(19) United States
(12) Patent Application Publication
(10) Pub. No.: US 2014/0244901 A1
(43) Pub. Date: Aug. 28, 2014

(54) METADATA MANAGEMENT FOR A FLASH DRIVE

(71) Applicant: LSI CORPORATION, San Jose, CA (US)

(72) Inventors: Siddharth Kumar Panda, Bangalore (IN); Thanu Anna Skariah, Bangalore (IN); Kunal Sablok, Bangalore (IN); Mark Ish, Atlanta, GA (US)

(73) Assignee: LSI CORPORATION, San Jose, CA (US)

(21) Appl. No.: 13/798,452

(22) Filed: Mar. 13, 2013

Related U.S. Application Data
(60) Provisional application No. 61/769,347, filed on Feb. 26, 2013.

(51) Int. Cl. G06F 12/02; G06F 3/06

(52) U.S. Cl. CPC G06F 12/0246; G06F 3/0644
USPC 711/103; 711/153

(57) ABSTRACT

An apparatus having one or more memories and a controller is disclosed. The memories are divided into a plurality of regions. Each regions is divided into a plurality of blocks. The blocks correspond to a plurality of memory addresses respectively. The controller is configured to (i) receive data from a host, (ii) generate metadata that maps a plurality of host addresses of the data to the memory addresses of the memories and (iii) write sequentially into a given one of the regions both (a) a portion of the data and (b) a corresponding portion of the metadata.

### FIELD OF THE INVENTION

The invention relates to nonvolatile drives generally and, more particularly, to a method and/or apparatus for implementing metadata management for a Flash drive.

### BACKGROUND

Flash memory is a type of memory device in which data blocks are erased before being written into another time. Data block erases involve moving the data blocks from an old place to a new place and then erasing the old place in a single operation. Flash memory also has a feature called wear leveling. Wear leveling moves the data blocks from one place to another to increase the life of the Flash memory. Because of wear leveling, an actual amount of data written to the Flash memory is multiple times the size of the data actually stored. Writing the same data multiple times is referred to as write amplification. Write amplification reduces a useful life of the Flash memory. Metadata is conventionally stored in the Flash memory apart from host data blocks. Therefore, regular updates to the metadata cause wear leveling and write amplification.

### SUMMARY

The invention concerns an apparatus having one or more memories and a controller. The memories are divided into a plurality of regions. Each region is divided into a plurality of blocks. The blocks correspond to a plurality of memory addresses respectively. The controller is configured to (i) receive data from a host, (ii) generate metadata that maps a plurality of host addresses of the data to the memory addresses of the memories and (iii) write sequentially into a given one of the regions both (a) a portion of the data and (b) a corresponding portion of the metadata.

### BRIEF DESCRIPTION OF THE FIGURES

Embodiments of the invention will be apparent from the following detailed description and the appended claims and drawings in which:

FIG. 1 is a block diagram of an example implementation of a system in accordance with an embodiment of the invention;

FIG. 2 is a diagram of an example division of a memory space of a memory circuit;

FIG. 3 is a diagram of an example population of on-disk metadata;

FIG. 4 is a diagram of an example metadata usage;

FIG. 5 is a flow diagram of an example method for a read-merge-write operation;

FIG. 6 is a diagram of an example utilization of an address space in a nonvolatile memory;

FIG. 7 is a flow diagram of an example method for managing metadata updates;

FIG. 8 is a functional flow diagram of an example method for nonvolatile memory queuing; and

FIG. 9 is a functional flow diagram of an example method to manage interactions among multiple modules.

### DETAILED DESCRIPTION OF THE PREFERRED EMBODIMENTS

Embodiments of the invention include providing metadata management for a Flash drive that may (i) make random host input/output patterns sequential, (ii) make host input/output transfers faster, (iii) make efficient use of a limited amount of nonvolatile random access memory space in a drive controller, (iv) reduce write amplification, (v) reduce wear leveling, (vi) flush map metadata from the nonvolatile random access memory to the Flash drive memory in regular intervals, (vii) process host writes in parallel with moving the metadata to the Flash drive memory and/or (viii) be implemented in one or more integrated circuits.

A Flash-memory-based solid-state drive (e.g., SSD) device generally comprises a controller and one or more Flash memory circuits. The controller includes a metadata circuit. The metadata circuit is designed to manage the storage of metadata in the Flash memory circuits. The metadata defines a map that relates host logical block addresses (e.g., LBA) of host input/output (e.g., I/O) data to physical block addresses (e.g., PBA) of the Flash memory circuits. Storage of the metadata in the Flash memory circuits helps maintain the LBA-to-PBA map across power cycles. Since the metadata is stored in the Flash memory, the metadata circuit manages writing the metadata in an efficient manner so that the metadata does not become significant overhead on the host I/O data. The on-disk metadata is managed in a distributed manner with the help of an intermediate nonvolatile random access memory (e.g., NVRAM) space to avoid the overhead caused by wear leveling in the Flash memory circuits.

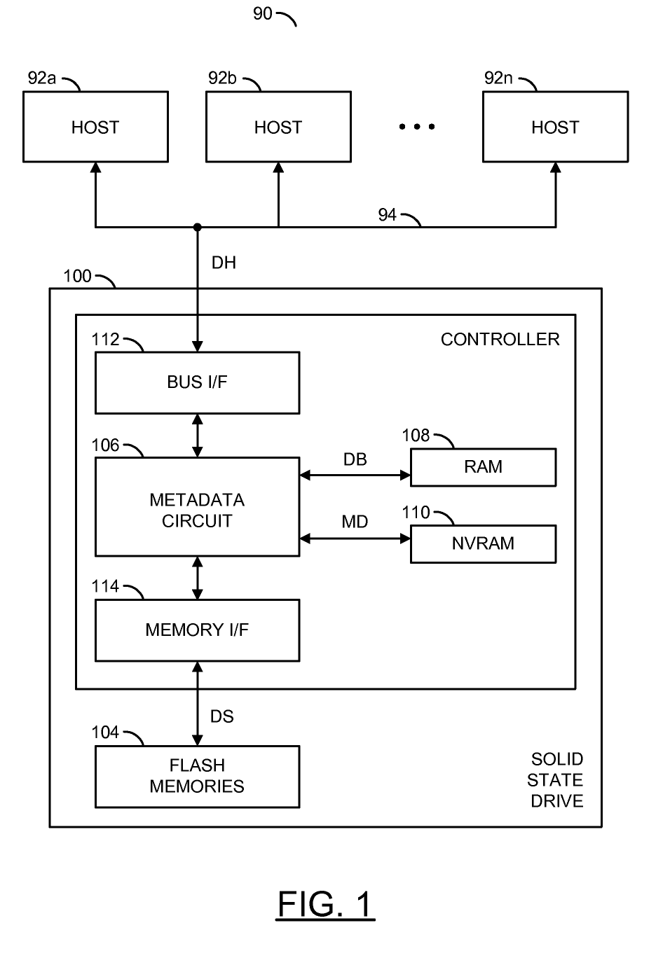

Referring to FIG. 1, a block diagram of an example implementation of a system 90 is shown in accordance with an embodiment of the invention. The system (or apparatus) 90 generally comprises one or more blocks (or circuits) 92a-92n, a network (or bus) 94 and one or more blocks (or circuits) 100. The circuit 100 generally comprises a block (or circuit) 102, a block (or circuit) 104 and a block (or circuit) 106. The circuit 102 generally comprises a block (or circuit) 106, a block (or circuit) 108, a block (or circuit) 110, a block (or circuit) 112 and a block (or circuit) 114. The circuits 92a to 114 may represent modules and/or blocks that may be implemented as hardware, software, a combination of hardware and software, or other implementations.

A signal (e.g., DH) is shown providing bidirectional communication between the circuits 92a-92n and the circuit 112. A signal (e.g., DB) is shown providing bidirectional communication between the circuit 106 and the circuit 108. Another signal (e.g., MD) is shown providing bidirectional communication between the circuit 106 and the circuit 110. A signal (e.g., DS) is shown providing bidirectional communication between the circuit 114 and the circuit 104.

The circuits 92a-92n implement host computers (or servers) and/or software applications. Each circuit 92a-92n is operational to read and/or write data to and from the circuit 100 via the network 94 in the signal DH. The circuits 92a-92n are also operational to present requests along with corresponding address information (e.g., host LBAs) to the circuit 100 in the signal DH. Furthermore, the circuits 92a-92n are operational to present commands in the signal DH to the circuit 100. The signal DH is also controlled by the circuit 100 to convey status information (e.g., cache hit, cache miss, etc.) from the circuit 100 back to the circuits 92a-92n.

The network 94 implements one or more digital communications network and/or busses. The network 94 is generally operational to provide communications between the circuits 92a-92n and the circuit 100. Implementations of the network 94 include, but are not limited to, one or more of the Internet, Ethernet, fibre optical networks, wireless networks, wired networks, radio frequency communications networks and/or backplane busses, such as a PCI express bus.

The circuit (or apparatus) 100 implements a Flash (or solid state) drive circuit. The circuit 100 is operational to store data received from the circuits 92a-92n via the signal DH. The circuit 100 is also operational to present data to the circuits 92a-92n via the signal DH in response to read commands. The circuit 100 could be part of a storage area network (e.g., SAN), network attached storage (e.g., NAS) and/or disk array subsystem (e.g., DAS) architecture. Typical storage capacities of the circuit 100 range from approximately 1 to 2 terabytes (e.g., TB). Other sizes may be implemented to meet the criteria of a particular application.

The circuit 102 is shown implementing a drive controller circuit. The circuit 102 is operational to control host I/O accesses to and from the circuit 104. Random LBA host writes into the circuit 104 are organized as serial PBA writes. Metadata that maps the LBA-to-PBA translations is stored locally within the circuit 102 and copied in pieces to the circuit 104. In some embodiments, the circuit 102 is implemented as one or more die (or chips or integrated circuits). The circuit 104 is shown implementing one or more storage volumes. The circuit 104 is operational to store data received from the circuit 102 via the signal DS in response to write commands. The circuit 104 is also operational to present data to the circuit 102 via the signal DS in response to read commands. The storage volumes may be implemented as logical volumes, virtual volumes and/or physical volumes. The circuit 104 generally includes one or more Flash memory circuits (or devices, dies, chips or integrated circuits). In some embodiments, the Flash memories may be NAND Flash memories. In some cases, the circuit 104 may be implemented on the same die as the circuit 102.

The circuit 106 is shown implementing a metadata control circuit. The circuit 106 is operational to (i) receive data from a host circuit 92a-92n, (ii) generate metadata that maps the host addresses of the data to the memory addresses of the memory circuit 104 and (iii) write sequentially into a given one of the regions both (a) a portion of the data and (b) a corresponding portion of the metadata. The circuit 106 is also operational to update and store metadata in the circuit 108 via the signal DB. The updating generally involves moving the metadata among active and passive data buffers within the circuit 108. The circuit 106 updates and stores the metadata buffered in the circuit 110 via the signal MD, copies the metadata to the circuit 104 and invalidates the metadata in the circuit 110 after the copy. During boot, the map metadata is loaded from the circuits 104 and/or 110 into the circuit 108. The circuit 106 also populates trim information for a region manager and control garbage collection operations. Efficient utilization of the circuit 110 is achieved by the circuit 106 by allowing parallel updates of mapping information to the circuit 110 while some part of the circuit 110 is being copied to the circuit 104.

The circuit 108 implements one or more buffer circuits. The circuit 108 is operational to store (or buffer) data, metadata and/or information for use by the circuits 102 and 104. In some embodiments, the circuit 108 is implemented as a random access memory (e.g., RAM). The circuit 108 is usually implemented as a volatile RAM. Other memory technologies may be implemented to meet the criteria of a particular application.

The circuit 110 implements one or more buffer circuits. The circuit 110 is operational to store (or buffer) metadata for use by the circuit 102. A typical storage capacity of the circuit 110 ranges from 4 kilobytes (e.g., KB) to 512 KB. In some embodiments, the circuit 110 is implemented as a nonvolatile random access memory (e.g., NVRAM). Other memory technologies may be implemented to meet the criteria of a particular application.

An entire address space of the circuit 104 is generally mapped by a global array of multiple (e.g., 32) bits. The global array contains metadata for mapping of the user I/O addresses to the physical addresses of circuit 104. An index of the global (or drive) array is the user application LBAs and a content of the global array is the PBAs.

All write requests that come from the circuits 92a-92n are written sequentially within an active region of the circuit 104. The map is updated with new metadata to account for the LBA-to-PBA change in the address of the write data. If some of the user application I/Os are overwrites, the previous PBA of the circuit 104 corresponding to the data being overwritten is marked as free. The regions are organized in a queue in a descending order of free space. Therefore, an initial region in the queue generally has the most free space. When more free space is requested, a freest region (e.g., an initial region in the queue) is designated as a target for garbage collection. The garbage collection generally uses a large sequential I/O to copy valid data from the target region to an active region. When all of the valid data has been copied to the active region, the entire target region is marked as free. The sequential copying of regions generally allows for a significant reduction in the write amplification.

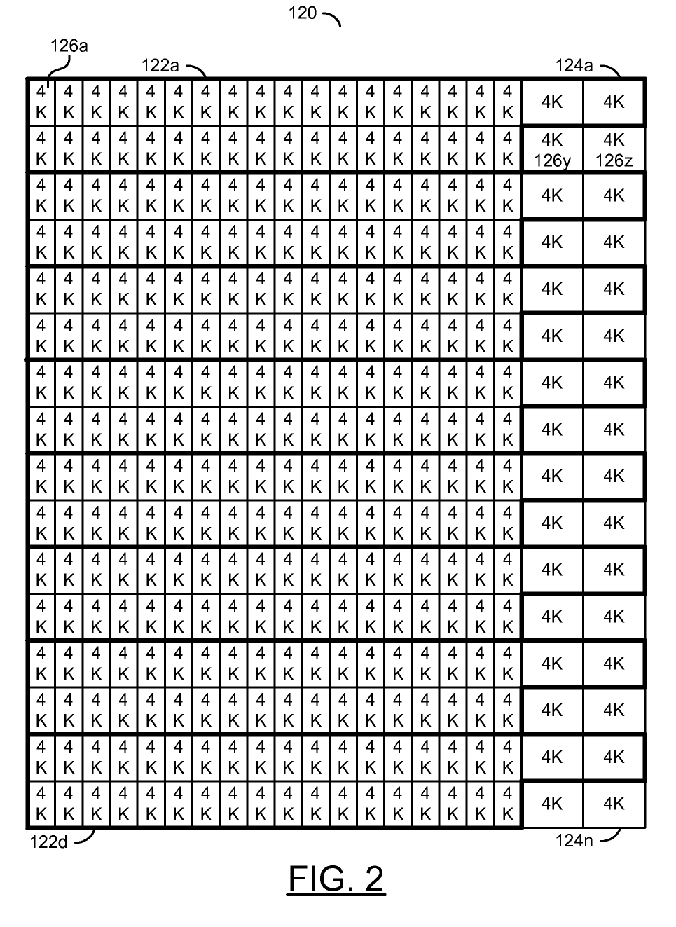

Referring to FIG. 2, a diagram of an example division of a memory space 120 of the circuit 104 is shown. The space 120 is divided into fixed-size areas 122a-122d. The areas 122a-122d are further divided into fixed-size regions 124a-124h. Each region 124a-124h is divided into fixed-size blocks 126a-126z. One or more of the blocks 126a-126z (e.g., the blocks 126y-126z) in each region 124a-124h are allocated to store a corresponding portion of the metadata. The remaining blocks 126a-126x in each region 124a-124h are allocated to store host data. Therefore, the metadata is distributed across memory space 120.

In some embodiments, the metadata blocks 126y-126z in each area 124a-124h store only the mapping of the host data stored in the blocks 126a-126x of the corresponding area. Locating the metadata blocks 126y-126z in predetermined (or fixed) locations in each area 124a-124h makes managing and interpreting the mapping information simple for the circuit 102. The metadata blocks 126y-126z contain a list of front-end host LBAs for the back-end PBAs in the corresponding region 124a-124h.

By way of example, consider the whole space 120 of the circuit 104 (e.g., 1280 KB) is visible to circuits 92a-92n. The space 120 is basically divided into equal sized blocks (or chunks) of 4 KB each as follows. The space 120 is divided into multiple (e.g., 4) similar-sized areas 122a-122d of 320 KB. Each area 122a-122d is further divided into multiple (e.g., 2) regions 124a-124h of 160 KB. Each region 124a-124 has many (e.g., 38) of the 4 KB blocks 126a-126x and a few (e.g., 2) of the 4 KB metadata blocks 126y-126z. The total number of entries in a single region 124a-124h is based on the use of the NVRAM space of the circuit 110.

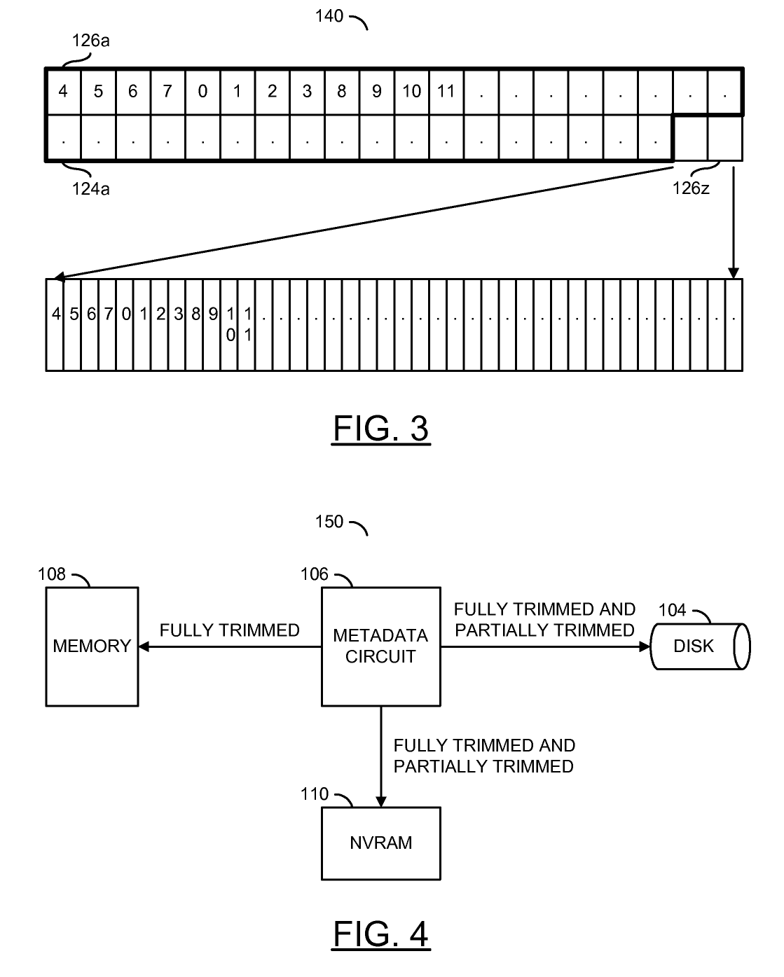

Referring to FIG. 3, a diagram of an example population 140 of on-disk metadata is shown. In the example, multiple (e.g., 3) different write sequences are received from the circuits 92a-92n. An initial write sequence involves host LBAs 4, 5, 6 and 7. In a normal case, the host data is allocated to the first four blocks 126a-126x in a single region 124a-124h (e.g., 124a). Indices 0-3 in the metadata blocks 126y-126z are used to store the host LBAs 4, 5, 6 and 7. A next write sequence is shown involving host LBAs 0, 1, 2 and 3. The host data is written into the region 124a sequentially following the host data from the initial write. Indices 4-7 in the metadata blocks 126y-126z are used to store the host LBAs 0, 1, 2 and 3. The next write sequence is shown involving host LBAs 8, 9, 10 and 11. The host data is written into the region 124a sequentially following the host data from the second write. Indices 8-11 in the metadata blocks 126y-126z are used to store the host LBAs 8, 9, 10 and 11. Subsequent host write are stored sequentially in the region 124a and the corresponding indices in the metadata blocks 126y-126z are updated accordingly.

The mapping information is also updated to the circuit 110. At any point in time, when metadata in the circuit 110 is flushed to the circuit 104, the metadata blocks 126y-126z in the corresponding region 124a-124h will contain the mapping information as shown in FIG. 3. The metadata contains all host write LBAs stored in sequential order starting from indices 0 of the metadata blocks 126y-126z.

Each entry (or unit) of mapping data generally consumes several (e.g., 4) bytes that point to a fixed-size data block as seen by the circuits 92a-92n. The on-disk metadata is also stored in fixed sized blocks. The metadata block size is configurable (e.g., 8K or 16K). Each metadata block 126y-126z contains a fixed number of mapping entries. The number of metadata entries in a block is also configurable. The number generally depends on the metadata block size, the buffer area in the circuit 110 and the flush rate, so that host I/Os will not be queued due to non-availability of space in the circuit 110. A metadata segment contains a single metadata block. The mapping data is stored in the circuit 110 and is flushed to the circuit 104 when the metadata segment from which host blocks are selected is changed.

A total number of entries in a single region 124a-124h generally depends upon the utilization of the circuit 110. Since the circuit 110 has a limited in size, and parallel processing of host I/O and metadata I/O updates are supported, the full space of the circuit 110 cannot be used to store mapping information. Therefore, the circuit 110 is divided into segments. A part of the circuit 110 is used to store mapping and is flushed to the circuit 104 when ready. At the same time, other part of the circuit 110 is used to store further host I/Os and metadata updates.

As part of initialization of the circuit 106, buffers in the circuits 108 and 110 are initialized. If no valid metadata is in the circuit 110 or the circuit 104, all of the internal structures are initialized to default values. The lack of valid metadata is determined by checking the circuits 104 and 110 for a lack of valid metadata signatures. If there are no valid metadata blocks, the host LBA-to-PBA mapping array is set to all trimmed.

The on-disk metadata is stored in fixed-size blocks 126y-126z at periodic addresses (e.g., after every 2038/4088 blocks in each region). On startup, the metadata is read from the fixed locations. Region sizes are allocated in integer multiples (e.g., 2040/4090) of the blocks 126a-126z. Once a metadata block 126y-126z is read, the metadata is checked for validity. The metadata signature and sequence numbers are used in the check. If the block is valid, the mapping information is updated according to the front-end index stored in the metadata entries.

After reading and applying all the metadata blocks 126y-126z, the NVRAM metadata block is read. The NVRAM mapped memory area is scanned for a valid metadata signature. If a valid signature is found, the sequence numbers are checked for any corruption. The metadata entries in the circuit 100 are subsequently applied to the mapping information. Multiple NVRAM valid blocks updates are supported.

Referring to FIG. 4, a diagram of an example metadata usage 150 is shown. Any random host data received by the circuit 102 is converted into sequential data by the circuit 102 before being written to the circuit 104. Hence, the font-end host LBAs can be random but the back-end PBAs are sequential such that the host data is always stored in a sequential manner in the regions 124a-124h. The circuit 106 takes benefit of the sequential host data storage by only storing the host LBAs in the mapping information, instead of storing both the host LBAs and the PBAs. Storing only the host LBAs translates into a small number (e.g., 4) of bytes to store a unit of mapping information in the circuits 104, 108 and 110. The back-end PBAs are not stored because the back-end PBAs are sequential in each region 124a-124h. Therefore, an initial mapping unit in a metadata block 126y-126z belongs to an initial back-end PBA in the corresponding region 124a-124h, a next mapping unit belongs to a next PBA, and so on.

Intermediate map metadata is also stored in the circuit 110. Since a capacity of the circuit 110 is generally limited, further refinements are used to store the metadata efficiently. When the size of the host I/Os are received in multiples of sequential data blocks (e.g., a host I/O size is 32 KB and each block 126a-126z can store 4 KB), a volume of all host LBAs from an initial LBA until an end LBA may exceed the capacity of the circuit 110. Therefore, the range of LBAs is compressed. For example, only the initial LBA (e.g., 4 bytes) and a count value (e.g., 1 byte) are stored in the circuit 110. The LBA compression efficiently utilizes the limited space of the circuit 110. During a flushing of the circuit 110 to the circuit 104, the compressed

LBA data is expanded before being written in the circuit 104.

Initially, the full address space of the circuit 110 is treated as single region. The circuit 106 stores the mappings of LBA-to-PBA translations in the circuits 108 and 110 until the host data is sufficient to fill most to all of a current region 124a-124h. When any host I/O data is received that maps to a new physical block allocated in another region 124a-124h than the current region 124a-124h, a currently used NVRAM space in the circuit 110 is flushed to the current region 124a-124b in the circuit 104. The just-flushed area of the circuit 110 is separated out from the rest of the NVRAM space and a next part of the circuit 110 services further host I/Os. When the flushing to the circuit 104 completes, the used area of the circuit 110 is invalidated and merged with current NVRAM space. As a result, the NVRAM space becomes divided into segments with some segments going to the circuit 104 for update and some segments coming back after the circuit 104 updates. Therefore, the circuit 110 is managed by the circuit 106 in a circular manner.

Local in-memory map metadata is generally maintained in the circuit 108 to make host reads faster than if reading the map metadata from the circuits 104 or 110 every time a host read request is serviced. Therefore, during booting of the circuit 102, the metadata is read from the circuits 104 and/or 110 and the in-memory mapping is updated in the circuit 108. Any available on-disk mappings is initially copied from the circuit 104 to the circuit 108. Afterwards, the metadata stored in the circuit 110 is read and merged with the in-memory mappings in the circuit 108. Each metadata block 126y-126z also stores a unique metadata signature that verifies the validity of the metadata stored therein.

Whenever an overwrite is received by the circuit 102 from a circuit 92a-92n, a corresponding previous mappings is automatically invalidated. No extra I/O is issued to invalidate the previous mapping. The invalidating operation is managed by including sequence numbers associated with every metadata blocks 126y-126z in the circuit 104. Every time that the metadata blocks 126y-126z are updated, the corresponding sequence number is incremented. During reboot, if multiple mappings of the same host LBA are found, the most recent (e.g., largest) sequence number indicates the latest mapping information as the metadata blocks 126y-126z are read in increasing order of the sequence numbers.

Updating the metadata occurs during host writes as well as during garbage collection I/O. Three copies of the metadata are generally updated: (i) a copy in the circuit 108 for easy access, (ii) a copy in the circuit 110 for recovery from a failure and (iii) a copy in the circuit 104 for persistence. The updates to the circuits 108 and 110 and performed for all data writes, other than overwrites. The on-disk update is performed at an end data update of the 2038/4088 data entries in the regions 124a-124h. The on-disk metadata write is serialized and included along with the previous 2038/4088 data writes.

A fixed number of buffers are maintained in the circuit 108 to update the metadata. At any point in time, a current buffer is active and the other buffers are passive. At the end of the updating data blocks to a current region 124a-124h, the metadata will be updated to the current region 124a-124h. Thus, the current active buffer is moved to a disk update buffer list and a free buffer is selected and assigned as the active buffer. Once the metadata update to the circuit 104 is over, the disk update buffer is put into the free list.

After every 2038/4088 data writes, a single metadata write to the circuit 104 is performed. All intermediate updates to the metadata go to the circuit 110 and 108. The circuit 110 is used as a cyclic buffer. In case of fully trimmed regions 124a-124h, once the 2038/4088 entries are filled, a disk write for the metadata is initiated. The metadata corresponding to a next set of data writes is updated to a next consecutive area. In case of partially trimmed regions 124a-124h, the data is written when a region switch happens. The metadata updates in the circuit 110 are similar to the updates in the circuit 108, except that the active and passive buffers in the circuit 110 point to the memory mapped address of the NVRAM block.

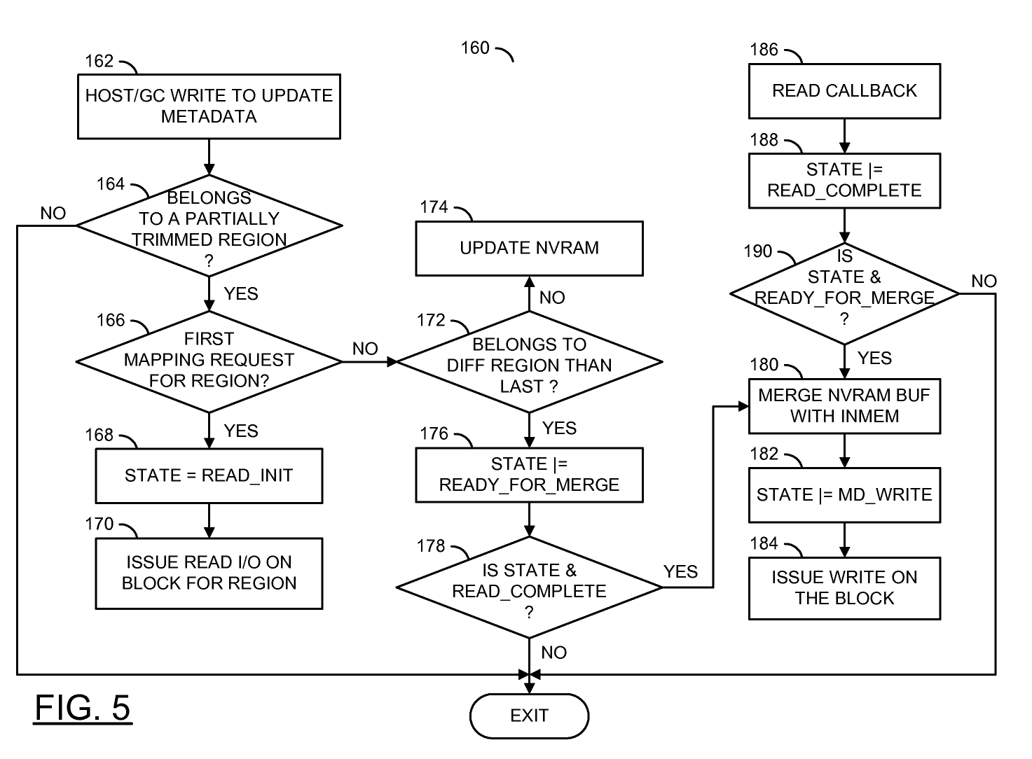

Referring to FIG. 5, a flow diagram of an example method 160 for a read-merge-write operation is shown. The method (or process) 160 is implemented by the circuit 102. The method 160 generally comprises a step (or state) 162, a step (or state) 164, a step (or state) 166, a step (or state) 168, a step (or state) 170, a step (or state) 172, a step (or state) 174, a step (or state) 176, a step (or state) 178, a step (or state) 180, a step (or state) 182, a step (or state) 184, a step (or state) 186, a step (or state) 188 and a step (or state) 190. The steps 162 to 190 may represent modules and/or blocks that may be implemented as hardware, software, a combination of hardware and software, or other implementations.

In the step 162, the circuit 102 receives a host write request or initiates a garbage collection. A check is made in the step 164 to determine if the write request belongs to a partially trimmed region 124a-124h or not. If not, the method 160 ends. If the write request belongs to a partially trimmed region 124a-124h, another check is made in the step 166 to determine if the request is an initial mapping request for the current region 124a-124h. If the write request is an initial mapping for the current region 124a-124h, the circuit 102 sets a state to an initial-read state in the step 168. In the step 170, the circuit 102 issues a read I/O on the current metadata blocks 126y-126z for the current region 124a-124h. The circuit 102 subsequently waits to receive a next block that has a different metadata index.

If the write request is not an initial mapping for the current region 124a-124h, a check is performed in the step 172 to determine if the write request should be routed to a different region 124a-124h other than the current region 124a-124h. If the write request is allocated to the current region 124a-124h, the metadata in the circuit 110 is updated in the step 174. If a new region 124a-124h should be used, the circuit 102 sets the state to a ready-for-merger state in the step 176.

The circuit 102 performs a check in the step 178. If the state is the ready-for-merger state and the read from step 170 is complete, the method 160 continues with the step 180. Otherwise, the method 160 ends. In the step 180, the circuit 102 merges the metadata in the circuit 110 with the metadata in the circuit 108.

The state is set to a metadata-write state in the step 182. In the step 184, the circuit 102 issues a write to a particular metadata block location.

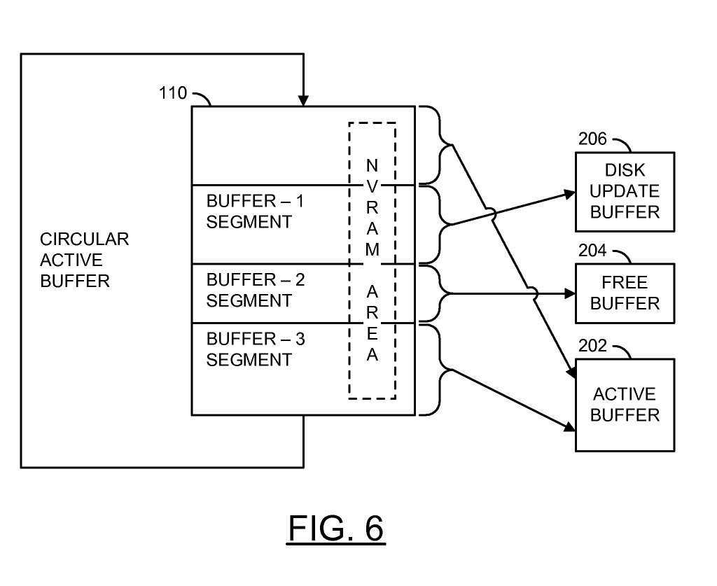

In the step 186, the circuit 102 receives a read callback from the read issued in the step 170. The circuit 102 sets the state to the read-complete state in the step 188. A check is made in the step 190 to determine if a merge should be performed. If a merge should be performed, the method 160 continues with the merger in the step 180. If not, the method 160 ends. Referring to FIG. 6, a diagram of an example utilization of the address space in the circuit 110 is shown. The NVRAM buffer area in the circuit 110 is used as a circular buffer. An active buffer segment 202 is where the metadata updates are happening currently. The active buffer segment 202 grows forward as more metadata is added. Parts of a buffer segment 204 can be merged with the active buffer segment 202 to accommodate the growth. The free buffer segment 204 is usually appended to the active buffer segment 202 if the free buffer segment 204 is the next consecutive buffer area for the active buffer segment 202 in the circular buffer. The metadata flush is initiated when a size of the free buffer region 204 approaches zero. During the flush, a disk buffer segment 206 is split from the active buffer segment 202. The remaining area in the active buffer is assigned as the new active buffer segment 202. The metadata in the disk buffer segment 206 is then flushed to the circuit 104. Once the flush is finished, the disk buffer segment 206 is cleared and made part of the free buffer segment 204.

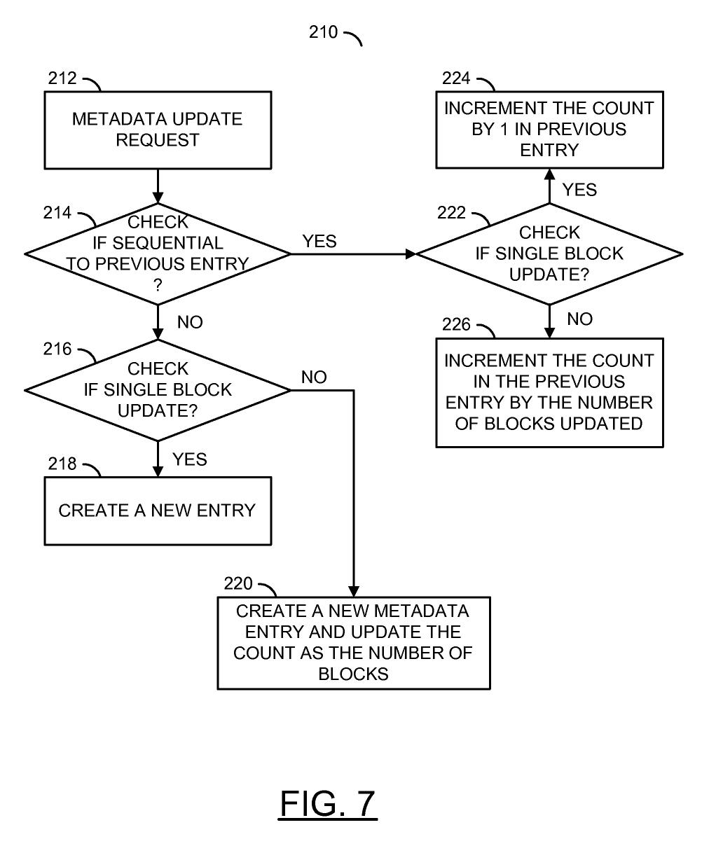

Referring to FIG. 7, a flow diagram of an example method 210 for managing metadata updates is shown. The method (or process) 210 is implemented in the circuit 102. The method 210 generally comprises a step (or state) 212, a step (or state) 214, a step (or state) 216, a step (or state) 218, a step (or state) 220, a step (or state) 222, a step (or state) 224 and a step (or state) 226. The steps 212 to 226 may represent modules and/or blocks that may be implemented as hardware, software, a combination of hardware and software, or other implementations.

Each region 124a-124h is either a fully trimmed region or a partially trimmed region. A fully trimmed region has all of the blocks 126a-126z free. A partially trimmed region has some of the blocks 126a-126z in a used state. The NVRAM storage of metadata differs based on the region type. In cases of fully trimmed regions 124a-124h, the data blocks 126a-126z are written sequentially. The PBA is derived from the metadata block location. The metadata block location is stored in a header and the metadata entries are the LBAs. In cases of partially trimmed regions, the data block 126a-126z selected could be anywhere in the region 124a-124h. Therefore, a metadata entry corresponding to a partially trimmed region contains both a PBA and an LBA.

In the step 212, the circuit 102 receives a metadata update request. During redirection of a single host write, the write could be directed to a single fixed size data block or to multiple data blocks, depending on the size of the host write I/O. The multiple blocks written for a single host write have sequential host block mappings. The different types of I/O redirections are based on the type of region selected and the host I/O block size. The types include (i) a sequential host block mapping on a fully free region, (ii) a non-sequential host block mapping on a fully free region, (iii) a sequential host block mapping on a partially free region with sequential back end indexes, (iv) a sequential host block mapping on a partially free region with non-sequential back end indexes and (v) a non-sequential host block mapping on partially free region.

A check is made in the step 214 to determine if the request is sequential to a previous entry. If not, another check is made in the step 216 to determine if the request is for a single block update. If the request is for a single block update, a new metadata entry is created in the step 218. If not, multiple blocks should be allocated for the host write and so a new metadata entry is created and the count is set to the number of host data blocks in the step 220. The multiple blocks are expected to be sequential. Therefore, sequential data blocks 126a-126x are allocated for the host data.

If the request is sequential to the previous entry, a check is made in the step 222 to determine if a single block is being updated. If the update is a single block, the count value for the previous entry is incremented by 1 in the step 224. If the update is for multiple blocks, the count value for the previous entry is updated by the number of blocks being updated in the step 226.

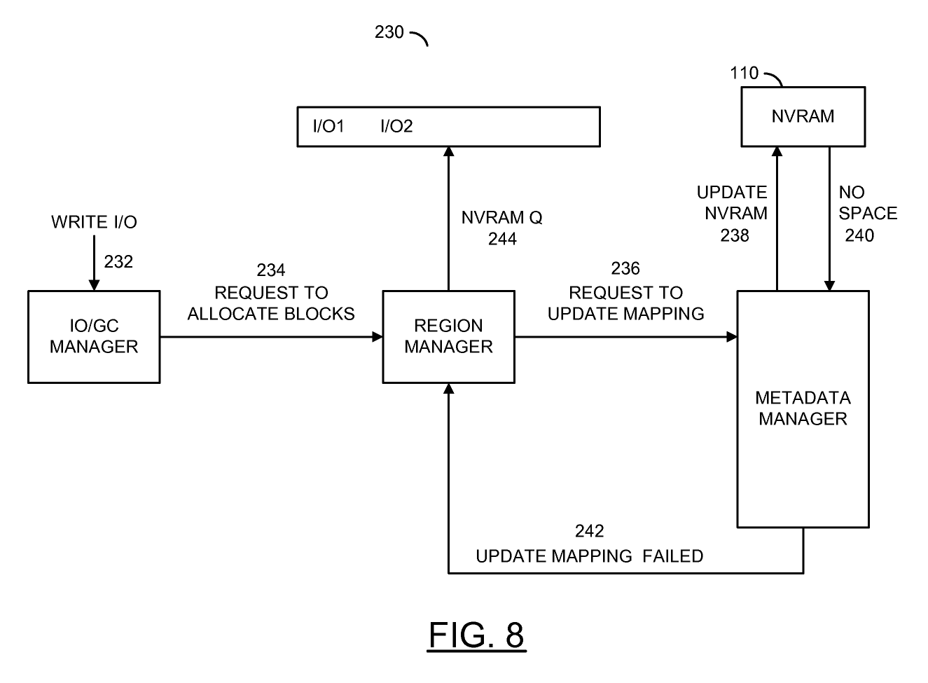

Referring to FIG. 8, a functional flow diagram of an example method 230 for nonvolatile memory queuing is shown. The method (or process) 230 is implemented by the circuit 102. The method 230 generally comprises a step (or state) 232, a step (or state) 234, a step (or state) 236, a step (or state) 238, a step (or state) 240, a step (or state) 242 and a step (or state) 244. The steps 232 to 244 may represent modules and/or blocks that may be implemented as hardware, software, a combination of hardware and software, or other implementations.

In the step 232, a write request is received by an input/output-garbage collection (e.g., IO/GC) manager in the circuit 102. The IO/GC manager requests an allocation of blocks in the step 234. A regional manager in the circuit 102 requests an update of the mapping in the step 236. A metadata manager in the circuit 102 checks the availability of the NVRAM space based on the request. In case of a fully trimmed region 124a-124h with a single entry, a few (e.g., 4) bytes of space are checked for availability and several (e.g., 28) bytes if a header is not allocated. In the case of a partially trimmed region 124a-124h with a single entry a few (e.g., 8) bytes of space are checked for availability and many (e.g., 32) bytes if a header is not allocated. In case of a multiple block update, the metadata manger checks for the size in the circuit 110 sufficient to hold the metadata update of all blocks in the multiple block update. If space is available in the circuit 110, the metadata manager will go ahead and update mapping in the circuit 110 in the step 238. If space is not available per the step 240, a FALSE value is returned to the region manager in the step 242. The region manager thus queues the I/O in the step 244 until space is available.

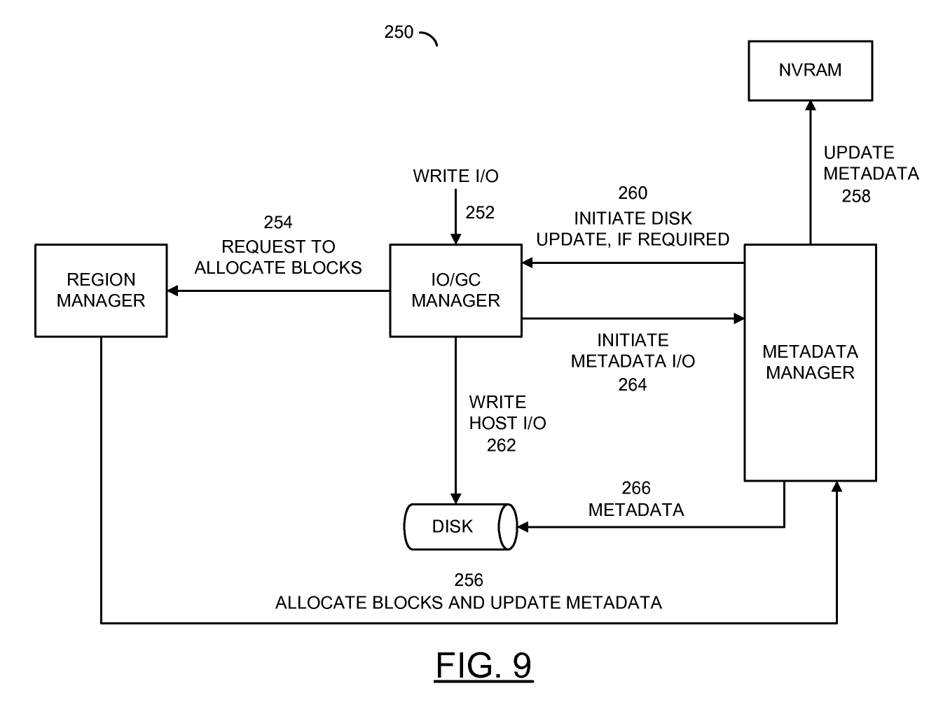

Referring to FIG. 9, a functional flow diagram of an example method 250 to manage interactions among modules is shown. The method (or process) 250 is implemented by the circuit 102. The method 250 generally comprises a step (or state) 252, a step (or state) 254, a step (or state) 256, a step (or state) 258, a step (or state) 260, a step (or state) 262, a step (or state) 264 and a step (or state) 266. The steps 252 to 266 may represent modules and/or blocks that may be implemented as hardware, software, a combination of hardware and software, or other implementations.

Other modules interact with metadata manager in the step 252 to update the metadata information. Furthermore, since the metadata flush is serialized along with host writes, the metadata disk writes are initiated from the IO/GC manager with a request to allocate blocks in the step 254. The regional manager response to the request in the step 256 to allocate blocks and update the metadata. The metadata manager updates the metadata if the circuit 110 in the step 258. The metadata manager also indicates to the IO/GC manager via a flag when metadata disk write should be performed in the step 260. The IO/GC manager writes the host data into the circuit 104 in the step 262 and informs the metadata manager in the step 264. The metadata manager updates the on-disk metadata in circuit 104 in the step 266.

The circuit 100 converts random host write patterns into sequential write patterns. As such, the metadata stores the mappings between the host LBAs and the drive PBAs efficiently in memory. To make host I/Os faster, a copy of the mapping information is stored within the circuit 102 and another copy is stored in the disk circuit 104. The circuit 102 synchronizes between the copies on regular intervals.

An unexpected power loss between two sync-ups of the mapping information between the circuit 102 and the circuit 104 may lose the last mapping if not flushed to the circuit 104. Therefore, the circuit 110 is provided to store a current copy of the un-flushed metadata.

Overhead of the metadata writes into the circuit 104 are reduced by serializing the metadata along with the host data. Therefore, write amplifications of Flash memory circuit 104 are not increased because of the metadata writes. The circuit 102 keeps the on-disk map metadata distributed across the circuit 104 address space at fixed locations to make sure wear that wear leveling performed by Flash controllers would be reduced.

Each host write results in a mapping entry to be stored. The mapping entry is stored in the circuit 108 for fast access and in the circuit 110 to recover the data in case of a power failure. The NVRAM space of the circuit 110 is limited so the metadata mappings is stored in an efficient manner. The NVRAM copy of the mappings is flushed to the circuit 104 in regular intervals for persistent storage. During power failures, the mappings is initially recovered quickly from the circuit 110 as the metadata locations are fixed and known in advance. After reading the mappings from circuit 110, if any, the mapping information is flushed to the circuit 104 before bringing up the drive.

During flushing of the NVRAM onto the disk, additional host writes may be received during the flushing of the NVRAM copy of the metadata. Therefore, the circuit 110 is managed such that host writes processed in parallel along with metadata writes onto disk. Therefore, the circuit 110 is always available to store new host mappings.

The functions performed by the diagrams of FIGS. 1-9 may be implemented using one or more of a conventional general purpose processor, digital computer, microprocessor, microcontroller, RISC (reduced instruction set computer) processor, CISC (complex instruction set computer) processor, SIND (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. An apparatus comprising:
one or more memories divided into a plurality of regions, wherein (i) each of said regions is divided into a plurality of blocks and (ii) said blocks correspond to a plurality of memory addresses respectively; and
a controller configured to (i) receive data from a host, (ii) generate metadata that maps a plurality of host addresses of said data to said memory addresses of said memories and (iii) write sequentially into a given one of said regions both (a) a portion of said data and (b) a corresponding portion of said metadata.

2. The apparatus according to claim 1, wherein said controller and said memories form a solid-state drive.

3. The apparatus according to claim 1, wherein (i) said controller comprises an internal memory that is nonvolatile and (ii) said controller is further configured to store said corresponding portion of said metadata in said internal memory.

4. The apparatus according to claim 3, wherein (i) said controller further comprises another memory and (ii) said controller is further configured to store all of said metadata in said other memory.

5. The apparatus according to claim 3, wherein (i) said controller is further configured to partition said internal memory into a plurality of segments arranged as a circular buffer and (i) said segments are sized to hold said corresponding portion of said metadata in a single one of said segments.

6. The apparatus according to claim 1, wherein said metadata as stored in said blocks is limited to said host addresses.

7. The apparatus according to claim 1, wherein a plurality of locations in said blocks that store said host addresses imply said memory addresses in said given region.

8. The apparatus according to claim 1, wherein said blocks that store said corresponding portion of said metadata are at one or more fixed locations in said given region.

9. The apparatus according to claim 1, wherein an order of said host addresses as received by said controller is random.

10. The apparatus according to claim 1, wherein said apparatus is implemented as one or more integrated circuits.

11. A method for managing metadata for a solid-state drive, comprising the steps of:
(A) receiving data at a controller from a host;
(B) generating metadata that maps a plurality of host addresses of said data to a plurality of memory addresses of one or more memories, wherein (i) said memories are divided into a plurality of regions, (ii) each of said regions is divided into a plurality of blocks and (iii) said blocks correspond to said memory addresses respectively; and
(C) writing sequentially into a given one of said regions both (i) a portion of said data and (ii) a corresponding portion of said metadata.

12. The method according to claim 11, wherein said controller and said memories form said solid-state drive.

13. The method according to claim 11, further comprising the step of:
storing said corresponding portion of said metadata in an internal memory of said controller that is nonvolatile.

14. The method according to claim 13, further comprising the step of:
storing all of said metadata in another memory of said controller that is volatile.

15. The method according to claim 13, further comprising the step of:
partitioning said internal memory into a plurality of segments arranged as a circular buffer, wherein said segments are sized to hold said corresponding portion of said metadata in a single one of said segments.

16. The method according to claim 11, wherein said metadata as stored in said blocks is limited to said host addresses.

17. The method according to claim 11, wherein a plurality of locations in said blocks that store said host addresses imply said memory addresses in said given region.

18. The method according to claim 11, wherein said blocks that store said corresponding portion of said metadata are at one or more fixed locations in said given region.

19. The method according to claim 11, wherein an order of said host addresses as received by said controller is random.

20. An apparatus comprising:
means for receiving data from a host;
means for generating metadata that maps a plurality of host addresses of said data to a plurality of memory addresses of one or more memories, wherein (i) said memories are divided into a plurality of regions, (ii) each of said regions is divided into a plurality of blocks and (iii) said blocks correspond to said memory addresses respectively; and
means for writing sequentially into a given one of said regions both (i) a portion of said data and (ii) a corresponding portion of said metadata.
